(19) United States
(12) Patent Application Publication
(10) Pub. No.: US 2009/0051141 A1
(43) Pub. Date: Feb. 26, 2009

(54) Portable rock crawl course

(76) Inventor: Michael A. Baer, Riverton, UT (US)

Correspondence Address: Michael A. Baer, 2131 Rainy Brook Court, Riverton, UT, 84065, US

(21) Appl. No.: 11/894,572

(22) Filed: Aug. 21, 2007

(51) Int. Cl. B62D 53/06

(52) U.S. Cl. 280/407.1

(57) ABSTRACT

A portable rock crawl course, including one or more trailers, each having a trailer bed, side walls, top panels, front end wall, and tailgate, each having synthetic rocks formed thereon and arranged such that when the walls, top panels and tailgates are pivoted to form a closed trailer, the synthetic rocks are nested inside and such that the side and end walls, top panels and tailgate are pivotable to form a crawl course over which vehicles travel, and wherein multiple trailers can be arranged to form multiple trailer crawl courses.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO MICROFICHE APPENDIX

Not Applicable.

### BACKGROUND OF THE INVENTION

1. Field of the Invention

The sport of “rock crawling” continues to increase in popularity. Rock crawling involves the driving of vehicles over large rock formations. Generally, in the past this has involved locating natural rock formations having a size, shape and texture to challenge the capability of vehicles and drivers attempting to drive over and through the rock formation. The vehicles used in this sporting activity are continually being modified to enable them to better crawl over or to pass around the rocks making up a rock formation to be challenged.

In the past, rock crawler drivers have selected natural rock formation and have driven to the formations to begin their attempts to pass over and through the natural rocks of a selected course.

Frequently people, other than the drivers attempting to traverse a course with their rock crawling vehicles, also show up at a course to watch the drivers and vehicles and to cheer on the drivers. Since the selected rock crawl courses are often difficult to access and may have limited areas from which viewers can observe, only a limited number of people can actually watch the activities. Also, if the rock crawl course is a natural rock formation, it may not be possible to charge a fee to watch the rock crawling. Naturally, the participants in a rock crawl would like to be able to charge a fee to observe and others would like to be able to financially benefit from presenting rock crawl events for which a fee can be charged to the public.

It has been determined that a large number of people would like to watch rock crawling, but are unable to be present at such events conducted at natural rock formations that are not easily accessed.

To make the sport more accessible to a larger number of people, sponsors have actually built rock crawling courses in arenas, stadiums and the like. Such manufactured courses have been particularly designed for a site and, generally can be used only at the particular site. The rock obstacles positioned at such sites require a great amount of time to construct, either by using actual natural rocks arranged to provide a challenging course, or by constructing simulated rocks from concrete or other materials at the selected site. Often, such constructed crawl courses must also be disassembled and removed after even a single use to allow the site to be used for other purposes.

When a rock crawling course is a natural rock formation, there is often potential danger to spectators as well as participants. The danger to spectators is reduced if the rock crawling course is formed, in place, in an arena, or the like, where spectators view the activities from a greater distance and often from behind barriers set up to protect the spectators. Built in place rock crawl courses are expensive to construct and remove.

The same design of safety achieved by building a rock crawl course in a stadium or arena, is achieved at lower costs by using a portable rock crawl course.

### OBJECTS OF THE INVENTION

Principal objects of the present invention are to provide a portable rock crawl course that is pre-formed on a vehicle or plurality of vehicles, easily transported to a stadium, an arena, or to other use sites; that is easily set up to provide a challenging crawl course; that is easily packed up and removed from the use site; and then is easily transported to another use site to again be set up for use. The portable crawl course can be moved from town-to-town and from one site to another, as for example, an outdoor stadium to an indoor arena where very large numbers of spectators can watch crawl vehicles attempt to traverse the set up course.

Additional objects and features of the invention will become apparent from the following detailed description of a preferred embodiment of the invention and the claims.

### FEATURES OF THE INVENTION

Principal features of the invention include the use of over-the-road transport vehicles, such as trailers that may be pulled by conventional tractors or prime-movers.

Each trailer includes simulated synthetic rock formations fixed to the side and front end walls and the tailgate so that the formations extend into the trailer when the trailer is prepared for over-the-road travel. Simulated synthetic rock formations may also be affixed to the trailer bed and/or top panels. The top panels, side, and front end wall and tailgate of the trailer are hinged to the trailer bed. Attached structure is provided for pivotally lowering and raising the front end wall, end side wall and tailgate between raised positions forming walls of the closed trailer and pivoted positions relative to the trailer bed and wherein the walls will engage similar walls of another similarly constructed trailer, or will engage the ground. The tops of the walls (when raised to form side and end walls of the trailer) may extend upwardly from the truck bed, or downwardly towards ground engagement.

Preferably the top of the trailer is formed to have a pair of centrally engaging top panels, each hingedly connected to a side wall. Each top flap is pivotable with the attached side walls from a position forming a closed top surface of the trailer or a pivoted position extending at an angle from the lowered edge of the side wall. Alternatively, the top of the trailer may be divided to provide panels having hinge connections to end walls or to both side and end walls.

When the side and end walls and top flaps are pivoted to be interconnected to form a closed trailer, synthetic simulated rocks, i.e., “syn-rocks”, formed on and affixed to inner surfaces of the walls, top flaps, front end wall, tailgate, and bottom project into the interior of the closed trailer and are shaped and arranged to nest inside the trailer. The syn-rock formations attached to and projecting from one interior surface do not engage the syn-rock formations on any other interior surface so as to prevent closure of the walls to form an enclosed trailer.

Additional objects and features of the invention will become apparent to those skilled in the art to which the invention pertains from the following detailed description, drawings and claims.

### THE DRAWINGS

In the Drawings

FIG. 1 is a perspective view of a prime-mover and a container trailer incorporating a portable rock crawl course of the invention;

FIG. 2, a perspective view of the trailer of FIG. 1, showing the side and end walls and top panels pivoted open;

FIG. 3, a rear elevation view of the trailer, with the trailer tailgate removed;

FIG. 4, a view like that of FIG. 3, taken on the line 4-4 of FIG. 2, with the front end wall removed for clarity and side walls, and top panels lowered to form a single trailer rock crawl course, and a four wheel drive vehicle traversing the syn-rocks formed on the walls and top flaps;

FIG. 5, a top plan view of a pair of trailers of a multiple trailer rock crawl course, with selected lowered trailer side walls, front end wall and tailgate, and top panels aligned together;

FIG. 6, an end elevation view of a pair of trailers, with beds and side walls, and top panels pivoted to make a typical multiple trailer rock crawl course configuration, and including jacks providing support for interconnected side walls and top panels;

FIG. 7, a schematic showing of interconnected side walls and top panels in a typical four trailer course arrangement with the trailers in side-by-side relationship; and

FIG. 8, a perspective view showing a typical trailer wall construction of the invention.

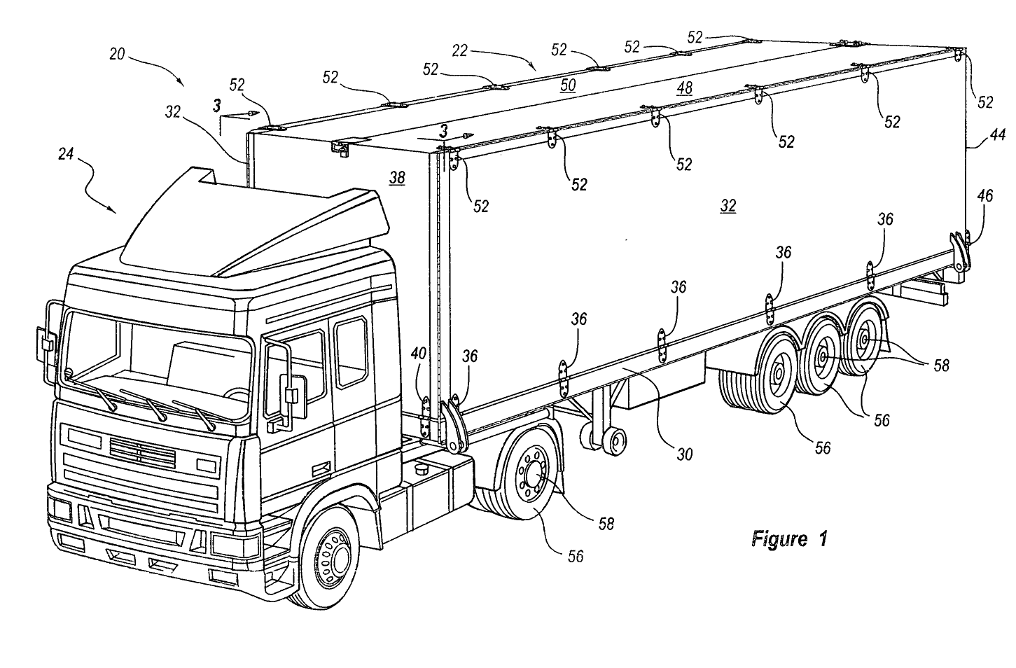

### DETAILED DESCRIPTION

Referring Now the Drawings

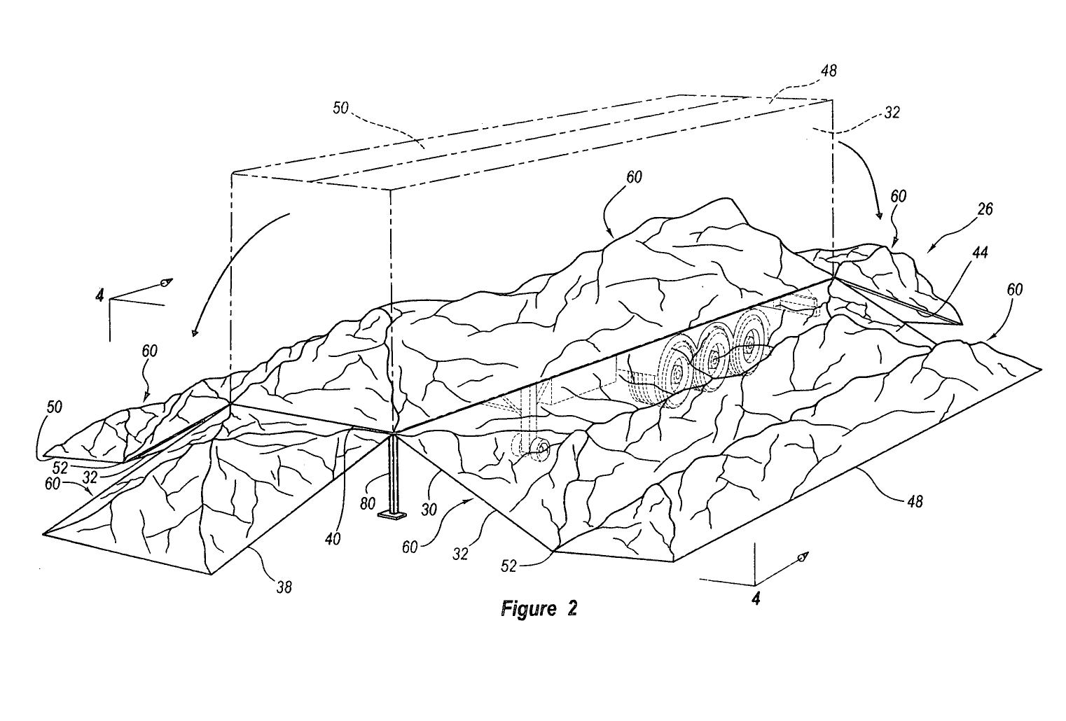

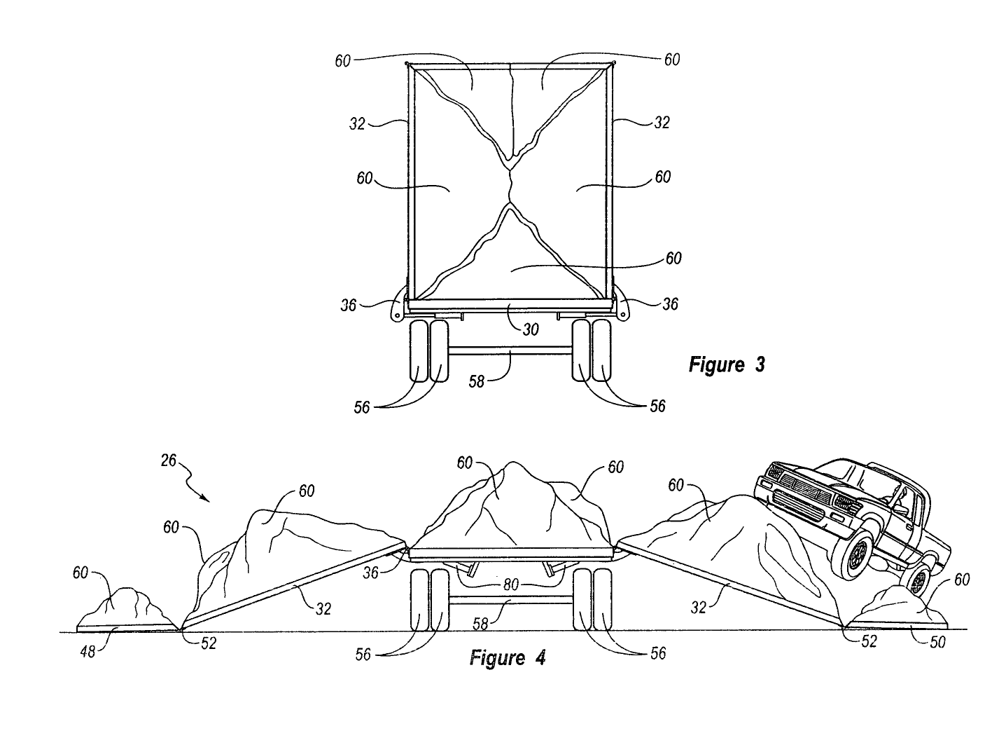

In the illustrated preferred embodiment, a single portable rock crawl course vehicle, shown generally at 20, includes at least one container trailer, shown generally at 22, and a prime-mover 24 that will pull the trailer 22 over highways and roads to locations where the single trailer rock crawl course vehicle 20 (FIGS. 2 and 4) is to be used. The locations of use may comprise stadiums, arenas, fair grounds, open fields, or other selected sites that will receive each prime-mover and attached container trailer, to be used in formation of a mobile rock crawl course.

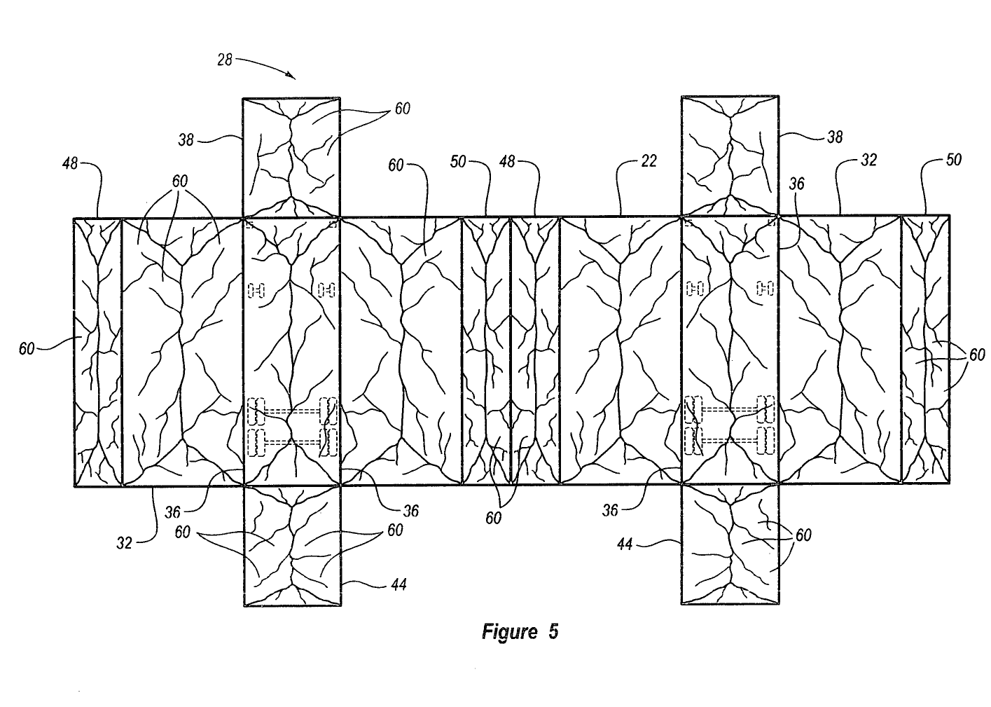

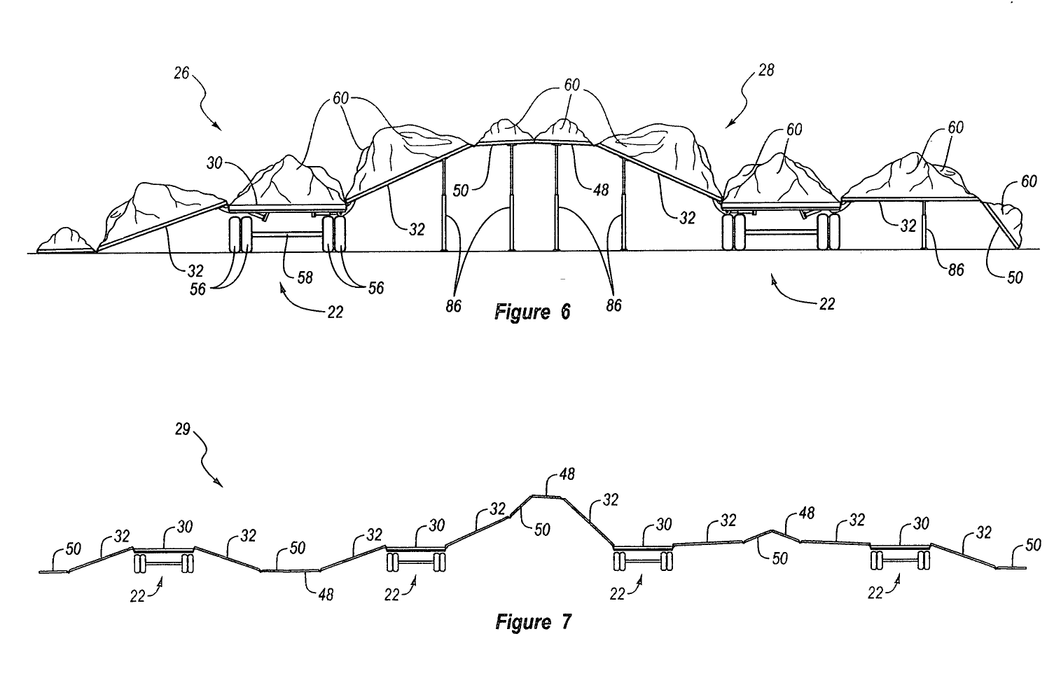

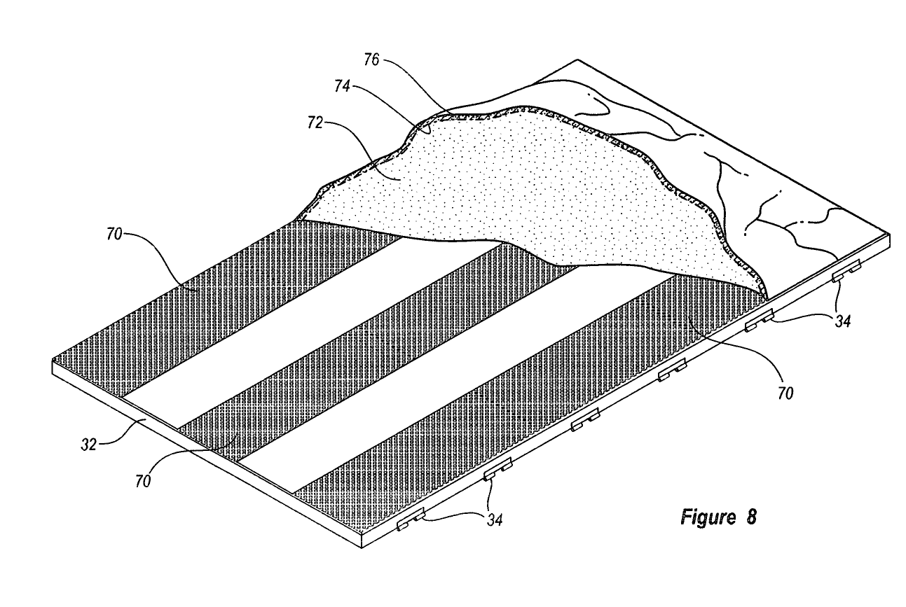

A movable single trailer rock crawl course 26 (FIGS. 2 and 4), can be transported by a single trailer 22, as shown in FIGS. 2 and 4. A multiple trailer crawl course may be formed as a mobile trailer course transported by a plurality of trailers 22. For example, a two trailer mobile crawl course is shown at 28 in FIGS. 5 and 6. A four trailer mobile crawl course is shown at 29 in FIG. 7. The same mobile crawl course set up may be varied, depending on factors such as available space, available trailers containing course components and layout connections of adjacent trailers. Trailers may be arranged side-by-side, or end to end or in a combination of side-by-side and end to end positions.

Each trailer 22 includes a trailer bed 30 having spaced apart side walls 32 connected to bed 30 by hinges 34.

Each trailer 22 also has a front wall 38 connected by a hinge 40 to bed 30 and extending between the spaced apart side walls 32.

A tailgate 44 has one edge connected by a hinge 46 to a rear edge of bed 30.

Top panels 48 and 50 each have one edge pivotally connected by hinges 52 to a side wall 32. The top panels 48 and 50 pivot about hinges 52 with respect to the side walls 32 to meet centrally between the side walls and to close the top of the trailer 22.

The undercarriage of each trailer 22 is conventional to container trailer construction and includes the usual wheels 56 and axles 58.

Prime-mover 24 is conventional and may be a truck to which the trailer is attached by a conventional coupling structure.

Synthetic, simulated rocks, i.e., “syn-rocks” shown generally at 60 are formed on, and project from the top of bed 30, and inner faces 31 (when the trailer is closed up) of the side walls 32, end wall 38, tailgate 44 and top panels 48 and 50.

The syn-rocks may take any desired shape, simulating the shape of actual rocks. However, the syn-rocks must be shaped to meet together and to allow the side walls 32, end wall 38, tailgate 44 and top panels 48 and 50 to pivot into position closing up the trailer 22.

While the syn-rocks 60 can each be formed of a variety of materials and using different construction techniques, it has been found that if the bed 30, side walls 22, end wall 38, tailgate 44 and top panels 48 and 50 are made of steel plate, the syn-rocks can be made of lighter materials that will stand up to the wear imposed by vehicles driven over them, as will be further explained.

Each syn-rock 60 is formed in place on a steel plate forming the trailer bed, side and end walls and tailgate by welding expanded steel 70 to the steel plates. Thereafter, a suitable, heavy duty foam plastic 72, or plastic with additives, such as rubber pellets or even metallic pieces is sprayed into and to project from the expanded steel. The foam material is applied to the desired shape of a desired syn-rock. A layer of mesh wire 74 is shaped to fit over the shaped foam and a layer 76 of gunnite concrete is applied over the mesh wire. Upon curing of the foam and gunnite concrete, the syn-rock 60, having the desired shape is formed and ready for vehicle travel thereover.

In setting up a single trailer crawl course 26 (FIGS. 2 and 4), side walls 32 and top panels 48 and 50 are pivoted from bed 30 into ground engagement.

One or more ground engaging support legs 80 may be provided to extend beneath and to provide additional support for the truck bed 30 when the truck bed is supporting syn-rocks 60 as part of a crawl course. Support jacks 86 are positioned beneath the constructed single trailer or multiple trailer crawl courses to provide further support for the syn-rocks and safety for vehicle operators.

Multiple trailer rock crawl courses, such as shown at 28 (FIGS. 5 and 6) and 29 (FIG. 7), are formed by combining single trailer rock crawl courses to form an extended rock crawl course.

Typically, a multiple trailer, i.e., two trailer rock crawl course 28, as shown in FIGS. 5 and 6, has a first trailer 22 with a side wall 32 and attached top panel 40 pivoted towards ground engagement, such that a vehicle, as shown at 90 (FIG. 4) can be driven onto the syn-rocks formed (but not shown in FIG. 7) on the bed 30, side walls 32, and wall 38, tailgate 44 and top panels 48 and 50. A second trailer 22 is positioned alongside the first trailer and the top panel 48 of the second trailer is positioned adjacent to and, if desired, connected to the top panel 58 of the first trailer 22.

A side wall 32 of the first trailer 22 and the attached top panel 48 of the first trailer are pivoted downwardly towards ground engagement to allow a vehicle 90 to be driven on, or off, depending on the direction of travel of the vehicle. The other side wall 32 of the first trailer may be pivoted to extend upwardly, to be parallel to the ground, or downwardly, as desired. The top panel 50 is aligned with (or connected to) the top panel 48 that is connected to a side wall 32 of the second trailer. The other side wall 32 of the second trailer and the top flap 50 thereof are pivoted downwardly for ground engagement. A vehicle 90 may be driven onto the course via top panel 48 of the first trailer 22, or via the top panel 50 of the second trailer 22 of rock crawl course 28.

In the multiple, four trailer, rock crawl course 29, four trailers 22 are arranged to be side-by-side.

Top panel 48 of a first trailer 22 at one end of crawl course 29 and top panel 50 of a fourth trailer 22 at an opposite end of crawl course 29 are ground engaging to permit a vehicle onto course 29 from either end thereof.

Top panel 50 of the first trailer is aligned with top panel 48 of a second trailer 22. Top panel 50 of the second trailer is aligned with top panel 48 of the third trailer 22 and top panel 50 of the third trailer is aligned with top panel 48 of the fourth trailer 22. The side walls 32 of the trailers are angled, as desired, to produce a rock crawl course 29 presenting a desired degree of challenge to drivers and vehicles.

Although preferred forms of my invention have been herein disclosed, it is to be understood that the present disclosure is by way of example and that variations are possible without departing from the subject matter coming within the scope of the following claims, which subject matter I regard as my invention.

I claim:

1. A mobile rock crawl course comprising
a rock crawl course container trailer;
said trailer having a trailer bed with synthetic rocks formed thereon and projecting upwardly therefrom;
spaced apart side walls having synthetic rocks formed on a face thereof and projecting therefrom; and
hinge means connecting said side walls to said bed, said synthetic rocks on said bed and said side walls nesting together inside said container trailer when said side walls are pivoted to form side walls of said container trailer.

2. A mobile rock crawl course as in claim 1, further including
at least one top panel pivotally connected to one of the side walls, each said top panel having synthetic rocks formed thereon and projecting therefrom to nest with the synthetic rocks on the side walls when said top panel is pivoted to provide a top surface for the container trailer.

3. A mobile rock crawl course as in claim 2, further including
a front end wall pivotally connected to the trailer bed; and
synthetic rocks fixed to and projecting from a surface of said front end wall, whereby the synthetic rocks on the first end wall nest inside the container trailer when said end wall is pivoted to be in engagement with said side walls.

4. A mobile rock crawl course as in claim 3, further including
a tailgate hinged to the trailer bed at the end thereof remote from the front end wall; and
synthetic rocks formed on a surface of said tailgate, said synthetic rocks on said tailgate nesting with the synthetic rocks on said side walls, end walls and at least one said top panel when said tailgate is pivoted to engage said side walls and said top wall to close up the container trailer.

5. A mobile rock crawl course as in claim 4, wherein at least one top panel comprises a pair of top panels, each pivotally connected to a side wall.

6. A mobile rock crawl course comprising
a plurality of rock crawl courses as in claim 1, positioned to have a top panel of one rock crawl course aligned with a top panel of another rock crawl course.

7. A mobile rock crawl course as in claim 1, wherein
each synthetic rock includes a wire mesh having a desired rock shape, a foam material filling and extending through said wire mesh and a concrete exterior extending over said foam material and said wire mesh material and said wire mesh.

8. A mobile rock crawl course as in claim 2, wherein
each synthetic rock includes a wire mesh having a desired rock shape, a foam material filling and extending through said wire mesh and a concrete exterior extending over said foam material and said wire mesh material and said wire mesh.

9. A mobile rock crawl course as in claim 3, wherein
each synthetic rock includes a wire mesh having a desired rock shape, a foam material filling and extending through said wire mesh and a concrete exterior extending over said foam material and said wire mesh material and said wire mesh.

10. A mobile rock crawl course as in claim 4, wherein
each synthetic rock includes a wire mesh having a desired rock shape, a foam material filling and extending through said wire mesh and a concrete exterior extending over said foam material and said wire mesh material and said wire mesh.

11. A mobile rock crawl course as in claim 6, further including
a support jack beneath at least one of said side walls, top panel, front end wall and tailgate.
